(19) United States
(12) Patent Application Publication
(10) Pub. No.: US 2023/0237991 A1
(43) Pub. Date: Jul. 27, 2023

(54) SERVER-BASED FALSE WAKE WORD DETECTION

(71) Applicant: Spotify AB, Stockholm (SE)

(72) Inventors: Daniel Bromand, Boston, MA (US); Björn Erik Roth, Stockholm (SE)

(73) Assignee: Spotify AB, Stockholm (SE)

(21) Appl. No.: 17/584,512

(22) Filed: Jan. 26, 2022

(51) Int. Cl. G10L 15/08; G10L 15/22; G10L 15/30

(52) U.S. Cl. CPC G10L 15/08; G10L 15/22; G10L 15/30; G10L 2015/088

(57) ABSTRACT

A wake word detector, at a server of a content delivery network (CDN) that provides audio (or other) content to a device, such as a voice-enabled device, detects false wake words in the audio content. The CDN wake word detector analyzes the audio stream to determine if the audio stream contains any audio that sounds like the wake word. If so, the CDN wake word detector can generate metadata that describes the time period, within the audio content, in which the false wake word was encountered. The metadata can include time offsets, from the start of the audio content, which can instruct a voice-enabled device to deactivate during the time period. This metadata is stored and then sent to the media-playback device requests the media content. The media-playback device can then instruct or inform the voice-enabled device of the presence of the false wake word. In this way, the wake word detector, at the voice-enabled device, is not activated to receive the false wake word.

### BACKGROUND

The use of digital assistants has become prolific. To converse with these digital assistants or other machine interfaces, humans often have to speak into a device to provide a command. The digital assistants can then provide an output, which is often synthesized speech that is audibly presented from a speaker attached to the device. While communicating with machine interfaces is often straightforward, the digital assistant can sometimes respond to sounds in the environment that were not meant to be commands for the digital assistant.

### SUMMARY

In general terms, this disclosure is directed to speech processing. In some embodiments, and by non-limiting example, the speech processing includes server-based false wake word detection.

One aspect is a method comprising: analyzing, by a server, an audio stream to be output with a voice-enabled device; generating, by the server, metadata associated with the audio stream, the metadata describing a portion in the audio stream that includes a false wake word; storing the metadata with the audio stream; and providing the metadata with the audio stream to a voice-enabled device.

Another aspect is a media-delivery system comprising: memory; a processor, in communication with the memory, that causes the media-delivery system to: analyze a media content item to be output to a media-playback device, wherein the media-playback device is in presence of a voice-enabled device; generate metadata associated with a media content item, the metadata describing a portion in the media content item that includes a false wake word; store the metadata with the media content item; and provide the metadata with the media content item to the media-playback device, wherein the media-playback device indicates to the voice-enabled device the presence of the false wake word.

A further aspect is a media-playback device comprising: memory; a processor, in communication with the memory, that causes the media-playback device to: receive a media content item to be output by the media-playback device in presence of a voice-enabled device; receive metadata associated with the media content item, the metadata describing a portion in the media content item that includes a false wake word; read the metadata; and based on the metadata, indicate to the voice-enabled device the presence of the false wake word in the media content item being received by the voice-enabled device.

### BRIEF DESCRIPTION OF THE FIGURES

The accompanying drawings, which are incorporated in and constitute a part of this disclosure, illustrate various examples of the present disclosure. In the drawings:

FIG. 1 is a block diagram of an environment for receiving speech input or providing speech output in accordance with aspects of the present disclosure;

FIG. 2A is a block diagram of a media-playback device and a media-delivery system for receiving speech input or providing speech output in accordance with aspects of the present disclosure;

FIG. 2B is another block diagram of the media-playback device and the media-delivery system for receiving speech input or providing speech output in accordance with aspects of the present disclosure;

FIG. 2C is a block diagram showing a process of locating false wake words (WWs) with the media-playback device or the media-delivery system in accordance with aspects of the present disclosure;

FIG. 3 is a block diagram of a media content item with metadata in accordance with aspects of the present disclosure;

FIG. 4 is a signaling or signpost diagram of signals processed by the devices and systems herein in accordance with aspects of the present disclosure;

FIG. 5 is a method diagram of a method for identifying false WWs in accordance with aspects of the present disclosure;

FIG. 6 is a method diagram of a method for instructing voice-enabled devices regarding false WWs in accordance with aspects of the present disclosure; and

FIG. 7 is a block diagram representing a computing system that may function within configurations described herein in accordance with aspects of the present disclosure.

### DETAILED DESCRIPTION

The following examples are explanatory only, and should not be considered to restrict the disclosure's scope, as described and claimed. Furthermore, features and/or variations may be provided in addition to those described. For example, example(s) of the disclosure may be directed to various feature combinations and sub-combinations described in the example(s).

The following detailed description refers to the accompanying drawings. Wherever possible, the same reference numbers are used in the drawings and the following description to refer to the same or similar elements. If a numeral is provided with an appended letter, these identifiers refer to different instances of a similar or same component. While example(s) of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The description herein relates to voice-enabled computer systems (or virtual assistants) that can receive voice commands from a user. In addition, the description relates to a system that provides media content (such as music) to the user.

Wake words (WWs) are often used to awaken a dormant voice-enabled computer system (or virtual assistant) and cause the systems/assistants to listen for a command. For example, with Spotify, the wake word/phrase, “Hey Spotify,” can be used to activate a Spotify-enabled device, and the wake word/phrase can be followed by a command, for example, “play Discover Weekly.” Upon receipt of the command, a content delivery network (e.g., a Spotify server) can provide an audio stream to the voice-enabled device, to cause the device to begin playing content by Discover Weekly.

The WW is helpful for privacy reasons because the device needs only listen for the wake word/phrase. Also, the wake word/phrase can also prevent the device from inadvertently activating and executing a command when someone says a phrase that could be misinterpreted as a command (e.g., if someone says “play Discover Weekly” without saying the wake word/phrase first). Many voice-enabled devices can also play audio content. So, for example, a Spotify-enabled device that can respond to voice commands, can often also play Spotify content. Still further, many voice-enabled devices are used within the same physical space as devices that play audio content and can receive or “hear” audio from those devices that play audio.

Unfortunately, some current voice-enabled devices can sometimes incorrectly activate in response to something that sounds like a WW but is actually in the content being played by the voice-enabled device or another device. As one particular example, Spotify contains a variety of original content called “Spotify Originals.” When the voice-enabled device plays that content, the content may include an audible announcement to the user that content is, “A Spotify Original.” The phrase “A Spotify” sounds like “Hey Spotify,” and this phrase can sometimes cause the wake word detector to incorrectly detect the “Hey Spotify” wake word by listening to the very content that the voice-enabled device is playing. The device may then stop the content or lower the volume of the content to start listening for a command. This pause or change in the content can annoy the listener.

The configurations and implementations herein may address the issues above by providing a wake word detector at a server, of a content delivery network (CDN) (e.g., the Spotify content service) that provides audio (or other) content to a device, e.g., a voice-enabled device. The CDN wake word detector analyzes the audio stream to determine if the audio stream contains any audio that sounds like the wake word (“hey Spotify”). If so, the CDN wake word detector can generate metadata that describes the time period, within the audio content, in which the false wake word was encountered. The metadata can include time offsets, from the start of the audio content, which can instruct a voice-enabled device to deactivate during the time period. In this way, the wake word detector, at the voice-enabled device, is not activated to receive the false wake word.

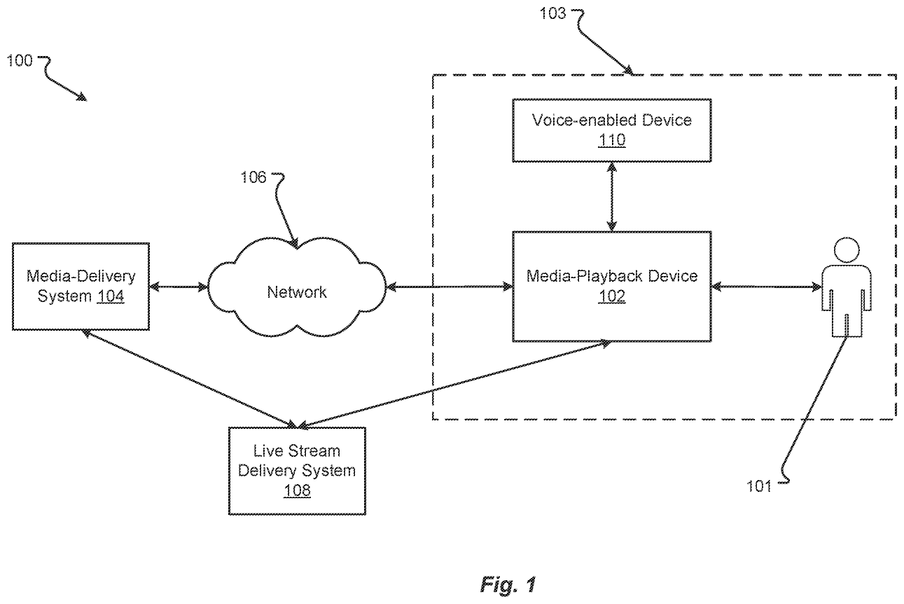

An environment 100 for receiving or providing speech input and/or speech or media output may be as shown in FIG. 1. The environment 100 can include a sound environment 103. The sound environment 103 can include the user 101, which may provide speech input to a user device, e.g., a media-playback device 102, and/or listen to media output. Further, the media-playback device 102 can provide the media and/or speech output to the user 101. The sound environment 103 may be simulated or may be real and physical, as being experienced by the user 101. The sound environment 103 can also include one or more voice-enabled devices 110.

The environment 100 may also include or communicate with a live stream delivery system 108. The live stream delivery system 108 can represent any type of server or cloud computing system/service that can deliver content to the media-playback device 102. The content delivered, by the live stream delivery system 108, can include live events for example, sporting events or news. Further, the live stream delivery system 108 can deliver content not previously consumed by the media-playback device 102 and that may not be stored at the media-delivery system 104. For example, the live stream delivery system 108 may provide podcasts. In some implementations, the media-playback device 102 may make requests for content from a live stream delivery system 108, but that content request may be rerouted through the media-delivery system 104, as explained herein.

Voice-enabled device(s) 110 can be any type of device that may be instructed or can be interacted with by voice commands. For example, the voice-enabled device 110 may have virtual digital assistants or other types of interactive software. Some examples of voice-enabled devices may be Google Assistant, Amazon Alexa, etc. The voice-enabled device 110 may be a function or a component of the media-playback device 102 or may be a physically separate device. In implementations, the media-playback device 102 may be a voice-enabled device 110, which can communicate over a local area network (LAN) located at the sound environment 103, and is present in the sound environment 103.

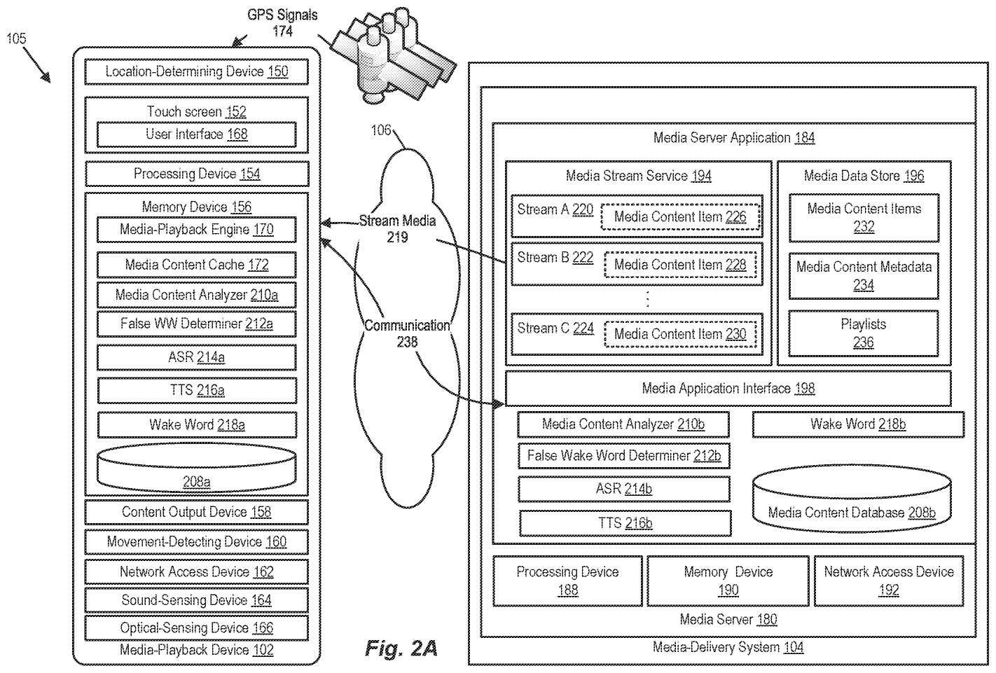

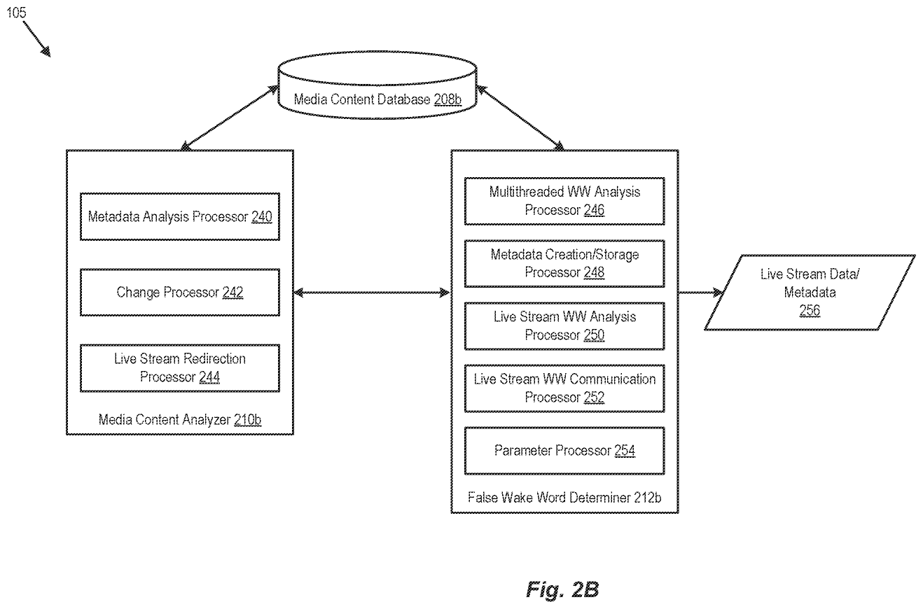

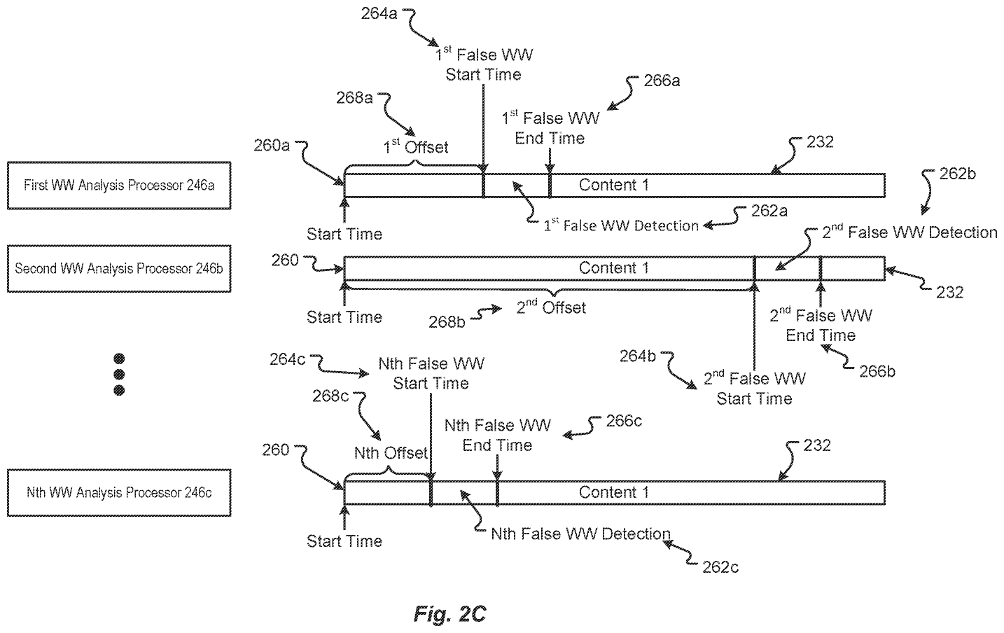

FIGS. 2A and 2B illustrate implementations of an example system 105 for interaction with a user, for example, in the environment 100. For example, the system 105 can function for media content playback. The example system 105 includes a media-playback device 102 and a media-delivery system 104. The media-playback device 102 includes a media-playback engine 170. The system 105 communicates across a network 106.

The media-playback device 102 can play back media content items to produce media output or perform other actions, including, but not limited to, reading text (e.g., audio books, text messages, content from a network, for example, the Internet, etc.), ordering products or services, interacting with other computing systems or software, etc. The output from these various actions is considered media content. While in some implementations, media content items are provided by the media-delivery system 104 and transmitted to the media-playback device 102 using the network 106. A media content item is an item of media content, including audio, video, or other types of media content, which may be stored in any format suitable for storing media content. Non-limiting examples of media content items include songs, albums, audiobooks, music videos, movies, television episodes, podcasts, other types of audio or video content, text, spoken media, etc., and portions or combinations thereof.

The media-playback device 102 plays media content for the user. The media content that is played back may be selected based on user input or may be selected without user input. The media content may be selected for playback without user input by either the media-playback device 102 or the media-delivery system 104. For example, media content can be selected for playback without user input based on stored user profile information, location, travel conditions, current events, and other criteria. User profile information includes but is not limited to user preferences and historical information about the user's consumption of media content. User profile information can also include libraries and/or playlists of media content items associated with the user. User profile information can also include information about the user's relationships with other users (e.g., associations between users that are stored by the media-delivery system 104 or on a separate social media site). Although the media-playback device 102 is shown as a separate device in FIG. 1, the media-playback device 102 can also be integrated with another device or system, e.g., a vehicle (e.g., as part of a dash-mounted vehicle infotainment system).

The media-playback engine 170 generates interfaces for selecting and playing back media content items. In at least some implementations, the media-playback engine 170 generates interfaces that are configured to be less distracting to a user and require less attention from the user than a standard interface. The less distracting interfaces may be configured by changing or adjusting one or more display parameters of the user interface elements, including, but not limited to, colors, transparency, size, shape, 3D effect, animation, etc. Implementations of the media-playback engine 170 are illustrated and described further throughout.

FIGS. 2A and 2B are schematic illustrations of an example system 105 for media content playback. In FIGS. 1, 2A and 2B, the media-playback device 102, the media-delivery system 104, and the network 106 are shown. Also shown are the user 101, the sound environment 103, and voice-enabled devices 110.

As noted above, the media-playback device 102 plays media content items. In some implementations, the media-playback device 102 plays media content items that are provided (e.g., streamed, transmitted, etc.) by a system external to the media-playback device 102, for example, the media-delivery system 104, a live stream delivery system 108, another system, or a peer device. Alternatively, in some implementations, the media-playback device 102 plays media content items stored locally on the media-playback device 102. Further, in at least some implementations, the media-playback device 102 plays media content items that are stored locally and media content items provided by other systems.

In some implementations, the media-playback device 102 is a computing device, handheld entertainment device, smartphone, tablet, watch, wearable device, or any other type of device capable of playing media content. In yet other implementations, the media-playback device 102 is an in-dash vehicle computer, laptop computer, desktop computer, television, gaming console, set-top box, network appliance, blue-ray or DVD player, media player, stereo, radio, smart home device, digital assistant device, etc.

In at least some implementations, the media-playback device 102 includes a location-determining device 150, a touch screen 152, a processing device 154, a memory device 156, a content output device 158, a movement-detecting device 160, a network access device 162, a sound-sensing device 164, and an optical-sensing device 166. Other implementations may include additional, different, or fewer components. For example, some implementations do not include one or more of the location-determining device 150, the touch screen 152, the sound-sensing device 164, and the optical-sensing device 166.

The location-determining device 150 is a device that determines the location of the media-playback device 102. In some implementations, the location-determining device 150 uses one or more of the following technologies: Global Positioning System (GPS) technology which may receive GPS signals 174 from satellites, cellular triangulation technology, network-based location identification technology, Wi-Fi positioning systems technology, and combinations thereof.

The touch screen 152 operates to receive an input from a selector (e.g., a finger, stylus, etc.) controlled by the user 101. In some implementations, the touch screen 152 operates as both a display device and a user input device. In some implementations, the touch screen 152 detects inputs based on one or both of touches and near-touches. In some implementations, the touch screen 152 displays a user interface 168 for interacting with the media-playback device 102. As noted above, some implementations do not include a touch screen 152. Some implementations include a display device and one or more separate user interface devices. Further, some implementations do not include a display device.

In some implementations, the processing device 154 comprises one or more central processing units (CPU). In other implementations, the processing device 154 additionally or alternatively includes one or more digital signal processors (DSPs), field-programmable gate arrays (FPGAs), Application Specific Integrated Circuits (ASICs), system-on-chips (SOCs), or other electronic circuits.

The memory device 156 operates to store data and instructions. In some implementations, the memory device 156 stores instructions for a media-playback engine 170 that includes the media-playback engine 170. In some implementations, the media-playback engine 170 selects and plays back media content and generates interfaces for selecting and playing back media content items. As described above, the media-playback engine 170 also generates interfaces for selecting and playing back media content items.

In at least some implementations, the media-playback engine 170 generates interfaces that are configured to be less distracting to a user and require less attention from the user than other interfaces generated by the media-playback engine 170. For example, interface(s) generated by the media-playback engine 170 may include fewer features than the other interfaces generated by the media-playback engine 170. These interfaces generated by the media-playback engine 170 may make it easier for the user to interact with the media-playback device 102 during travel or other activities that require the user's attention.

Some implementations of the memory device also include a media content cache 172, which may be a component of the media content database 208. The media content cache 172 stores media content items, such as media content items that have been previously received from the media-delivery system 104. The media content items stored in the media content cache 172 may be stored in an encrypted or unencrypted format. The media content cache 172 can also store decryption keys for some or all of the media content items that are stored in an encrypted format. The media content cache 172 can also store metadata about media content items such as title, artist name, album name, length, genre, mood, era, etc. The media content cache 172 can also store playback information about the media content items, such as the number of times the user has requested to playback the media content item or the current location of playback (e.g., when the media content item is an audiobook, podcast, or the like for which a user may wish to resume playback), the presence of false WWs, etc.

The memory device 156 typically includes at least some form of computer-readable media. Computer-readable media includes any available media that can be accessed by the media-playback device 102. By way of example, computer-readable media include computer-readable storage media and computer-readable communication media.

Computer-readable storage media includes volatile and nonvolatile, removable and non-removable media implemented in any device configured to store information such as computer-readable instructions, data structures, program modules, or other data. computer-readable storage media includes, but is not limited to, Random Access Memory (RAM), Read Only Memory (ROM), Electrically Erasable Programmable Read Only Memory (EEPROM), flash memory and other memory technology, Compact Disc-Read Only Memory (CD-ROM), blue ray discs, digital versatile discs or other optical storage, magnetic cassettes, magnetic tape, magnetic disk storage or other magnetic storage devices, or any other medium that can be used to store the desired information and that can be accessed by the media-playback device 102. In some implementations, computer-readable storage media is non-transitory computer-readable storage media.

Computer-readable communication media typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer-readable communication media includes wired media such as a wired network or direct-wired connection, and wireless media such as acoustic, radio frequency, infrared, and other wireless media. Combinations of any of the above are also included within the scope of computer-readable media.

The content output device 158 operates to output media content. In some implementations, the content output device 158 generates media output for the user 101 that is directed into a sound environment 103, for example, an interior cabin of the vehicle. Examples of the content output device 158 include a speaker assembly comprising one or more speakers, an audio output jack, a Bluetooth transmitter, a display panel, and a video output jack. Other implementations are possible as well. For example, the content output device 158 may transmit a signal through the audio output jack or Bluetooth transmitter that can be used to reproduce an audio signal by a connected or paired device such as headphones, speaker system, vehicle head unit, etc.

The movement-detecting device 160 senses movement of the media-playback device 102. In some implementations, the movement-detecting device 160 also determines an orientation of the media-playback device 102. In at least some implementations, the movement-detecting device 160 includes one or more accelerometers or other motion-detecting technologies or orientation-detecting technologies. As an example, the movement-detecting device 160 may determine an orientation of the media-playback device 102 with respect to a primary direction of gravitational acceleration. The movement-detecting device 160 may detect changes in the determined orientation and interpret those changes as indicating movement of the media-playback device 102. The movement-detecting device 160 may also detect other types of acceleration of the media-playback device and interpret those acceleration as indicating movement of the media-playback device 102 too.

The network access device 162 operates to communicate with other computing devices over one or more networks, such as the network 106. Examples of the network access device include one or more wired network interfaces and wireless network interfaces. Examples of wireless network interfaces include infrared, BLUETOOTH® wireless technology, 802.11a/b/g/n/ac, and cellular or other radio frequency interfaces.

The network 106 is an electronic communication network that facilitates communication between the media-playback device 102, the media-delivery system 104, or other devices or systems. An electronic communication network includes a set of computing devices and links between the computing devices. The computing devices in the network use the links to enable communication among the computing devices in the network. The network 106 can include routers, switches, mobile access points, bridges, hubs, intrusion detection devices, storage devices, standalone server devices, blade server devices, sensors, desktop computers, firewall devices, laptop computers, handheld computers, mobile telephones, vehicular computing devices, and other types of computing devices.

In various implementations, the network 106 includes various types of links. For example, the network 106 can include wired and/or wireless links, including Bluetooth, ultra-wideband (UWB), 802.11, ZigBee, cellular, and other types of wireless links. Furthermore, in various implementations, the network 106 is implemented at various scales. For example, the network 106 can be implemented as one or more networks, Local Area Networks (LANs), metropolitan area networks, subnets, Wide Area Networks (WANs) (such as the Internet), or can be implemented at another scale. Further, in some implementations, the network 106 includes multiple networks, which may be of the same type or of multiple different types.

The sound-sensing device 164 senses sounds proximate the media-playback device 102 (e.g., sounds within a vehicle in which the media-playback device 102 is located). In some implementations, the sound-sensing device 164 comprises one or more microphones. For example, the sound-sensing device 164 may capture a recording of sounds from proximate the media-playback device 102. These recordings may be analyzed by the media-playback device 102 using speech-recognition technology, e.g., the Automatic Speech Recognition (ASR) 214a, 214b, to identify words spoken by the user. The words may be recognized as commands from the user that alter the behavior of the media-playback device 102 and the playback of media content by the media-playback device 102. The words and/or recordings may also be analyzed by the media-playback device 102 using natural language processing and/or intent-recognition technology to determine appropriate actions to take based on the spoken words.

Additionally or alternatively, the sound-sensing device 164 may determine various sound properties about the sounds proximate the user such as volume, dominant frequency or frequencies, duration of sounds, pitch, etc. These sound properties may be used to make inferences about the sound environment 103 proximate to the media-playback device 102, such as the amount or type of background noise in the sound environment 103, whether the sensed sounds are likely to correspond to a private vehicle, public transportation, etc., or other evaluations or analyzes. In some implementations, recordings captured by the sound-sensing device 164 are transmitted to the media-delivery system 104 (or another external server) for analysis using speech-recognition and/or intent-recognition technologies.

The optical-sensing device 166 senses optical signals proximate the media-playback device 102. In some implementations, the optical-sensing device 166 comprises one or more light sensors or cameras. For example, the optical-sensing device 166 may capture images or videos. The captured images can be processed (by the media-playback device 102 or an external server, for example, the media-delivery system 104 to which the images are transmitted) to detect gestures, which may then be interpreted as commands to change the playback of media content, or to determine or receive other information.

Similarly, a light sensor can be used to determine various properties of the environment proximate the user computing device, such as the brightness and primary frequency (or color or warmth) of the light in the environment proximate the media-playback device 102. These properties of the sensed light may then be used to infer whether the media-playback device 102 is in an indoor environment, an outdoor environment, a private vehicle, public transit, etc.

The media-delivery system 104 comprises one or more computing devices and provides media content items to the media-playback device 102 and, in some implementations, other media-playback devices as well. The media-delivery system 104 can also include a media server 180. Although FIG. 2 shows a single media server 180, some implementations include multiple media servers. In these implementations, each of the multiple media servers may be identical or similar and may provide similar functionality (e.g., to provide greater capacity and redundancy, or to provide services from multiple geographic locations). Alternatively, in these implementations, some of the multiple media servers 180 may perform specialized functions to provide specialized services (e.g., services to enhance media content playback, to analyze spoken messages from the user 101, to synthesize speech, etc.). Various combinations thereof are possible as well.

The media server 180 transmits a media stream 219 to media-playback devices, such as the media-playback device 102. In some implementations, the media server 180 includes a media server application 184, a processing device 188, a memory device 190, and a network access device 192. The processing device 188, memory device 190, and network access device 192 may be similar to the processing device 154, memory device 156, and network access device 162 respectively, which have each been previously described.

In some implementations, the media server application 184 streams audio, video, or other forms of media content. The media server application 184 includes a media stream service 194, a media data store 196, and a media application interface 198. The media stream service 194 operates to buffer media content such as media content items 226, 228, and 230, for streaming to one or more streams 220, 222, and 224.

The media application interface 198 can receive requests or other communication from media-playback devices 102 or other systems, to retrieve media content items from the media server 180. For example, in FIGS. 2A and 2B, the media application interface 198 receives communication 238 from the media-playback engine 170.

In some implementations, the media data store 196 stores media content items 232, media content metadata 234, and playlists 236. The media data store 196 may comprise one or more databases and file systems. As noted above, the media content items 232 may be audio, video, or any other type of media content, which may be stored in any format for storing media content.

The media content metadata 234 operates to provide various information associated with the media content items 232. In some implementations, the media content metadata 234 includes one or more of title, artist name, album name, length, genre, mood, era, the presence of false WWs, etc. The playlists 236 operate to identify one or more of the media content items 232 and. In some implementations, the playlists 236 identify a group of the media content items 232 in a particular order. In other implementations, the playlists 236 merely identify a group of the media content items 232 without specifying a particular order. Some, but not necessarily all, of the media content items 232 included in a particular one of the playlists 236 are associated with a common characteristic such as a common genre, mood, or era. The playlists 236 may include user-created playlists, which may be available to a particular user, a group of users, or to the public.

Each of the media-playback device 102 and the media-delivery system 104 can include additional physical computer or hardware resources. In at least some implementations, the media-playback device 102 communicates with the media-delivery system 104 via the network 106.

Although in FIGS. 2A and 2B, only a single media-playback device 102 and media-delivery system 104 are shown, in accordance with some implementations, the media-delivery system 104 can support the simultaneous use of multiple media-playback devices, and the media-playback device can simultaneously access media content from multiple media-delivery systems. Additionally, although FIGS. 2A and 2B illustrate a streaming media based system for media playback during travel, other implementations are possible as well. For example, in some implementations, the media-playback device 102 includes a media content database 208, and the media-playback device 102 is configured to select and playback media content items without accessing the media-delivery system 104. Further in some implementations, the media-playback device 102 operates to store previously streamed media content items in a local media data store (e.g., the media content cache 172).

In at least some implementations, the media-delivery system 104 can be used to stream, progressively download, or otherwise communicate music, other audio, video, or other forms of media content items to the media-playback device 102 for playback during travel on the media-playback device 102. In accordance with an implementation, a user 101 can direct the input 176 to the user interface 168 to issue requests, for example, to playback media content for playback during travel on the media-playback device 102.

Components that may be part of the media-playback device 102 and/or the media-delivery system 104 may be as shown in FIGS. 2A and 2B. The components shown FIGS. 2A and 2B can include one or more of, but are not limited to, a media content analyzer 210a, 210b, a false WW determiner 212a, 212b, and/or a media content database 208a, 208b. The components shown in FIGS. 2A and 2B may be provided to locate false WWs in media content, create metadata indicating the location of the false WWs in the media content, and store and provide the metadata with the media content. Portions of either the media-delivery system 104 or the media-playback device 102 may perform some or all of the functions described herein in conjunction with the components 208-210.

In implementations, the media-playback device 102 can also include a media content analyzer 210, which can interact with the media content database 208. Media content analyzer 210 can determine changes within the media content database 208. For example, the media content analyzer 210 can determine if and when new content has been added to the media content database 208 that has not been analyzed for false WWs. Further, the media content analyzer 201 may operate to organize content for the false WW determiner 212. Media content analyzer 210 may be in communication with the false WW determiner 212 to provide information required by the false WW determiner 212 to analyze the content in the media content database 208 and the media content cache 172.

The false WW determiner 212 can analyze content within the media content database 208 to determine one or more false WWs within an item of media content. The false WW determiner 212 can analyze the content for one or more types of wake words. Further, upon discovering a false WW, the false WW can generate metadata that may be stored with the media content cache 172, in the media content database 208. When receiving media content at the media-playback device 102, the content may include the metadata having the false WW information provided by the false WW determiner 212 of the media-delivery system 104. An example of the false WW determiner 212 and the media content analyzer 210 may be as shown in FIG. 2B.

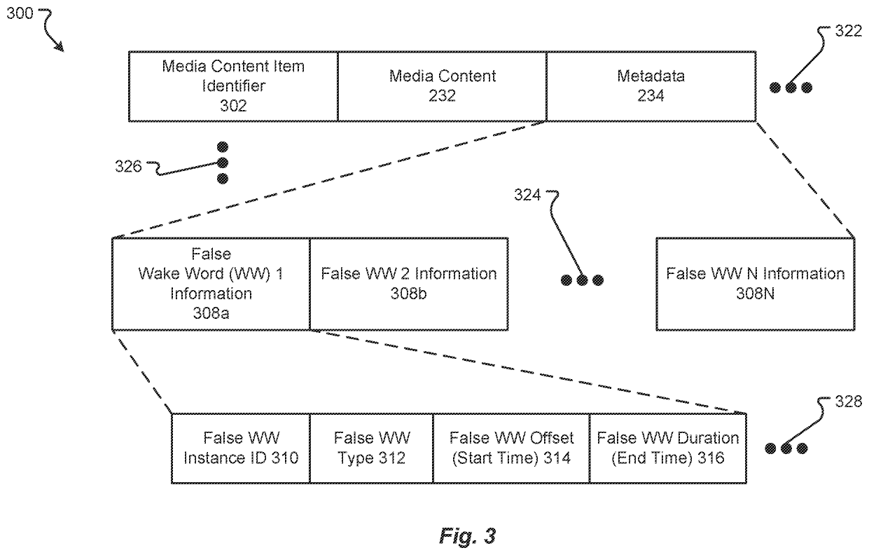

The media content database 208 can be any type of database (e.g., flat-file databases, relational database, etc.) for storing the media content data and/or metadata. An example of at least some of the data structures 300 that may be stored in the media content database 208 may be as shown in FIG. 3.

Another implementation of the media-playback device 102 and the media-delivery system 104 may be as shown in FIG. 2B. With these implementations of the media-playback device 102 and the media-delivery system 104, the media content can be analyzed for false WWs.

Metadata analysis processor 240 can determine if content within the media content database 208 contains metadata associated therewith. Thus, the metadata analysis processor 240 can analyze media content items 232 to determine if the media content items 232 have been analyzed by the false WW determiner 212 and has false WW information stored within the media content metadata 234 of the media content items 232. If the media content items 232 is shown to or determined not to have false WW information, the media content item 232 may be sent to the false WW determiner 212 to be analyzed.

In implementations, the file change processor 242 can determine if a media content item 232 has changed. For example, the file change processor 242 can compare creation dates of the media content item 232, or determine an edit date for the media content item 232, or conduct other analysis to determine when an update to media content item 232 has been made. If an update has been made, the file change processor 242 may signal that media content item 232 may need to be reevaluated by the false WW determiner 212. Thus, the file change processor 242 can create and store a flag or other type of metadata with the media content item 232 that may be read by the false WW determiner 212 to indicate that the false WW analysis of the content may be needed or be repeated.

A live stream redirection processor 244 can redirect live stream data from being delivered directly to the media-playback device 102 and rerouting that live stream data to the media-delivery system 104. Thus, the live stream redirection processor 244 can operate to receive a request for live-streamed or podcast data from the media-playback device 102 and can reroute this request to the media-delivery system 104, which may then retrieve that requested content. The requested content may then be evaluated for false WWs before being sent back to the media-playback device 102. In this way, the systems in environment 100 can provide false WW determinations for the media-playback device 102, even when the requested content is not provided from or currently stored in the media content database 208.

In implementations, the false WW determiner 212 can include a multithreaded WW analysis processor 246. The multithreaded WW analysis processor 246 may execute one or more threads or instances of a WW analysis processor to analyze media content item 232 for WWs. In implementations, the multithreaded WW analysis processor 246 can have one or more threads that analyze the media content item 232 for a particular WW. Thus, for each WW that may exist within the sound environment 103, for example, “Hey Siri,” “Hey Google,” “Alexa,” etc., a different thread of the multithreaded WW analysis processor 246 may analyze the content for that false WW. In additional or alternative configurations, the multithreaded WW analysis processor 246 may have two or more threads analyzing for the same WW but analyzing on different portions of the media content item 232. In this way, the analysis of the media content item 232 may be completed more quickly by parsing the media content item 232 into separate portions for analysis. Regardless, the multithreaded WW analysis processor 246 can analyze the content for multiple instances of the false WW.

The false WW determiner 212 can also include a metadata creation/storage processor 248, which can receive the information from the multithreaded WW analysis processor 246, about the possible false WWs within the content. The metadata creation/storage processor 248 may then generate media content metadata 234 that is stored with media content item 232. The media content metadata 234 a may include some type of time offset or time indication which indicates when the false WW may occur in the media content item 232. This false WW information can be stored with the media content item 232 and later sent to the media-playback device 102 to provide to voice-enabled devices 110 through live stream data/metadata 256.

A live stream WW analysis processor 250 can analyze any live stream data from the live stream delivery system 108. In implementations, the live stream WW analysis processor 250 operates to provide real-time WW analysis of media not stored currently at the media-delivery system 104. In this way, the media-delivery system 104 can still provide the media content metadata 234 that describes false WWs in the live stream but was not previously evaluated because the content is live data. The live stream WW analysis processor 250 can provide the same or similar information as the multithreaded WW analysis processor 246. This WW information may be provided to the media-playback device 102 as part of the live stream.

The live stream WW communication processor 252 can generate information about false WWs for the live stream data as included live stream data/metadata 256. Thus, the live stream WW communication processor 252 can insert metadata within the live stream for the media-playback device 102.

A parameter processor 254 can change the processing of the WW analysis processors 246, 250. The parameters can include information provided by the user or other systems or devices that can manipulate how the WW will be identified. Each WW or content is evaluated for WWs based on a predetermined speech pattern. The parameters can change how the WW is located by requesting the false WW processors 246, 250 look for words that are more or less similar to the WW. Thus, by changing the one or more of pitch, frequency, delay, amplitude, or other parameters of the false WW detection, the envelope or number of different false WWs that can be detected may be changed. The parameter processor 254 can provide these parameters to the WW analysis processors 246, 250 to change their analysis.

Live stream data/metadata 256 can include any type of stream data being sent to the media-playback device 102. This information can include the media content item 232, live-stream data, and/or the media content metadata 234 that are used by the media-playback device 102 to instruct voice-enabled devices 110 about false WWs. Embodiment of this type of information may be as shown in FIG. 3.

The ASR 214 can recognize speech input from the user into the media-playback device 102. The speech may be provided in the sound environment 103. The ASR 214 may then analyze the speech to determine what was said.

A Text-To-Speech (TTS) 216a, 216b function can change text-to-speech. Thus, any type of audio feedback from the media-playback device 102 to the user 101 may be changed by the TTS 216. These operations can include converting any inputs, such as text messages or emails being read by the media-playback device 102, but also administrative messages being spoken to the user 101. The TTS 216 can also be engaged based on false WWs. However, the TTS 216 may be prevented from activating by the false WWs when those false WWs are identified, and the TTS 216 is instructed to deactivate during the false WW or ignore the false WW.

The WW detection function 218a, 218b can receive a WW. To determine the WW within a recording, the WW detection function 218 can apply a data structure. This data structure can allow the WW detection function 218 to better search for the WW within the recordings of the sound environment 103. When a false WW is detected in media content, the WW detection function 218 can be instructed to deactivate during the false WW or ignore the false WW.

An implementation of the determination of the false WW may be as shown in FIG. 2C. The multithreaded WW analysis processor 246 may create or generate several instances of the WW analysis processor instances 246a-246c (e.g., first WW analysis processor instance 240a, a second WW analysis processor instance 240b, etc.). In one implementation, a single media content item 232 may be reviewed by several instances of the multithreaded WW analysis processor 246. Each of these instances may be looking for different type of WW. For example, a first thread (e.g., a first WW analysis processor instance 240a) may be looking for the “Alexa” WW. In contrast, the third thread of the multithreaded WW analysis processor 246 may be evaluating the content for false WWs similar to “Hey Spotify.” The multithreaded WW analysis processor 246 threads can also analyze different media content items 232 in parallel or at the same time.

Each media content item 232 has a start time 260. When evaluating the media content item(s) 232 for false WWs, the multithreaded WW analysis processor 246 can begin comparing portions of the media content item(s) 232 to audio signals that are similar to or represent a particular WW. Upon detecting a match between the portion of content item 232 and the audio signal representing the WW, and at a predetermined confidence interval, the multithreaded WW analysis processor 246 determines that a first false WW has been detected (in false WW detection 262a-262c) and begins at a start time 264a-264c and ends at time 266a-266c. Start time 264 and end time 266 can determine a time period for the false WW detection 262. The start time 264 may be represented by an offset 268a-268c from the start time 260 of the media content item(s) 232. In this way, the content characteristics can describe when the false WW may occur and when the false WW will end. The other multithreaded WW analysis processors 246b, 246c may evaluate different portions of the media content item(s) 232 or may identify different WWs. The other multithreaded WW analysis processor 246 can locate other false WW detections 262b, 262c at different offsets 268b, 268c, with different start times 264b, 264c and end times 266b, 266c. This information about offsets, start and end times, types of false WWs, etc. may be provided for storage as media content metadata 234 for the media content item 232.

An implementation of a data structure, data store, or database 300, which may store one or more items of metadata associated with false WWs may be as shown in FIG. 3. The media content data structure 300 may be the same or similar to data structures included in the media content database 208. Each different type of media content may include a data structure 300. As there may be different types of media content, there may be more or fewer data structures 300 than that shown in FIG. 3, as represented by ellipses 328. Each data structure 300 can include one or more of, but is not limited to, a media content item ID 302, media content 232, and/or media content metadata 234. Each data structure 300 can include more or fewer data portions or fields than those shown in FIG. 3, as represented by ellipses 322.

Media content item ID 302 can be any type of ID, including, but not limited to, a numeric ID, and alphanumeric ID, a globally unique ID (GUID), etc. The media content ID 302 can allow media content to be identified, indicated, and communicated to the different components within the system 105.

Media content 232 can include any type of media data including audio, video, multimedia, etc. Media content 232 can include any type of frames or other types of data that is used to playback and provide the media data to a media-playback device 102.

Media content metadata 234 can include all the information about false WWs or other types of information. Media content metadata 234 may be created and stored with each item a media content 232. In this way, the false WWs are attached with or are part of the data provided with the media content 232. The media content metadata 234 can include one or more instances of false WW information 308a-308N. There may be more or fewer instances of false WW information 308 than that shown in FIG. 3, as represented by ellipses 324.

False WW information 308 can include information about a false WW that was detected, for example, as shown in FIG. 2C. Each different instance of false WWs that are detected within the media content item(s) 232 may be provided as a different set of false WW information, for example, 308b, 308N. As explained previously, the false WW information 308 can include one or more of, but is not limited to: a false WW instance identifier (ID) 310, a type of false WW 312, a false WW offset 314 (for the start time of the false WW within the media content item(s) 232), and/or an end time 316 for the instance of the false WW (or the duration of the false WW detection 262). The false WW information 308 can have more or fewer items of information than that shown in FIG. 3, as represented by ellipses 328.

The false WW instance ID 310 can include any type of identifier. For example, the ID 310 can include an alphanumeric, numeric, a globally unique identifier (GUID), or other type of ID. The ID uniquely identifies this false WW instance in the media content metadata 234.

The false WW type 312 can represent an indication of a false WW that was detected. For example, the false WW type can include an indication that the WW was for “Hey Google,” “Hey Spotify,” etc. Thus, each item of false WW information 308 can be associated with a different type of WW and can allow the media-playback device 102 to instruct two or more voice-enabled devices 110 of the existence of false WWs. Thus, any type of voice-enabled device 110, within the sound environment 103, may enjoy the benefit of having false WWs determined in the media content 232 and receiving instructions to prevent interacting with those false WWs.

The false WW offset (start time) 314 can be the time offset 268 from the start time 260 to the start time 264 of the false WW detection 262. The offset 268 may be represented as minutes, seconds, and/or time divisions less than a second. In other implementations, the false WW offset (start time) 314 is a time when the false WW will occur. This time can be a timer or other indication of a time, understood jointly by the media-playback device 102 and the voice-enabled device 110.

The false WW duration (end time) 316 is similar to the start time information 314 but indicates a time 266 indicating the end of the false WW instance. This information 316 may be represented also by an offset from the start time 260 or by an offset from the start time 264 of the false WW detections 262. In this way, the beginning and end of the false WW detection 262 may be documented in the metadata 234.

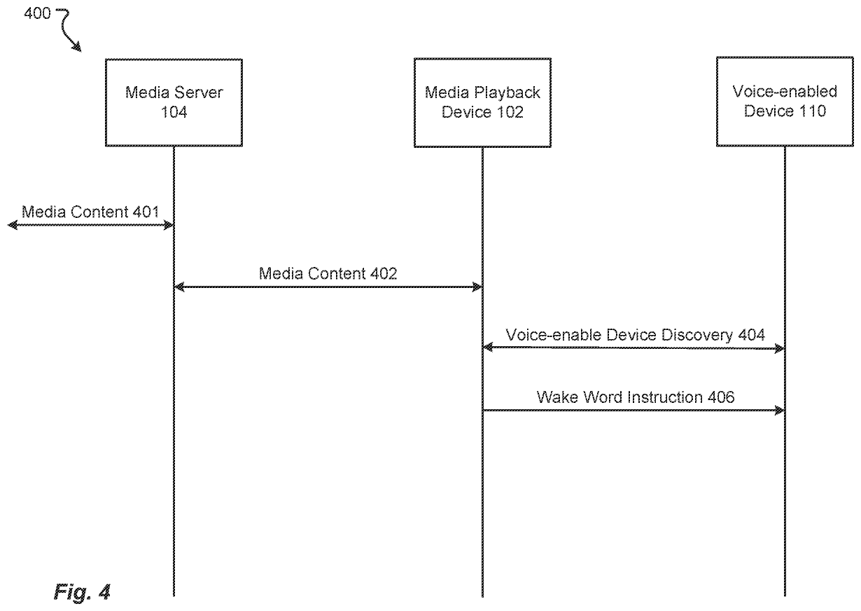

An embodiment of a signaling process 400 may be as shown in FIG. 4. The messages or communications may be sent between the media-playback device 102, a voice-enabled device 110, and the media-delivery system 104. The signals may be communicated over one or more networks 106 or directly between devices through wired or wireless connections. Further, the signals may be sent with any of the one or more communication methods, standards, processes, etc. as explained herein or as understood by one skilled in the art.

The media content signal 401 may represent the requests for and/or the input of media content 232. Media server 180 may request and/or receive various items of media content 232 on a periodic and/or continual basis. The media content item 232 may be provided in the content signal 401 and stored by the media server 180 in the media content database 208. Upon receiving new or changed media content items 232, the media server 180 can determine false WWs within that media content. Sometime thereinafter, the media-playback device 102 may request the media content from the media server 180.

Media content signal(s) 402 can include the media content 232 (with media content metadata 234) provided by the media server 180 and requested by the media-playback device 102. Media contact signal 402 can include the media content 232 but also the media content metadata 234 associated with the media content. The media-playback device 102 can analyze the media content metadata 234 to determine various instances of false WWs within the media content 232. Media-playback device 102 may then determine the different voice-enabled devices 110, within the sound environment 103, based on a voice-enabled device discovery signal(s) 404.

Voice-enabled device Discovery 404 can include any handshake signals or other types of discovery processes used by the media-playback device 102 to determine various voice-enabled devices 110 within the sound environment 103. These different processes can include evaluating Bluetooth or other wireless signals used to synchronize or associate different devices together. The signals 404 may occur before the media content 232 is received. Upon receiving the media content signal 402, with the media content metadata 234, the media-playback device 102 can begin to determine what instructions to send to various voice-enabled devices 110 to indicate the presence of possible false WWs.

Wake word instruction(s) 406 can be the instruction signal(s) from the media-playback device 102 to the voice-enabled device(s) 110 that can indicate the presence of a false WW that may be received by the voice-enabled device(s). This instruction can include the information from the media content metadata 234, including the time offset 314 and end time 316. The instruction 406 may be sent to each individual voice-enabled device 110 based on matching the voice-enabled device 110 with the false WW type 312. These instructions allow the voice-enabled device 110 to ignore or disable itself to prevent reacting to the false WW.

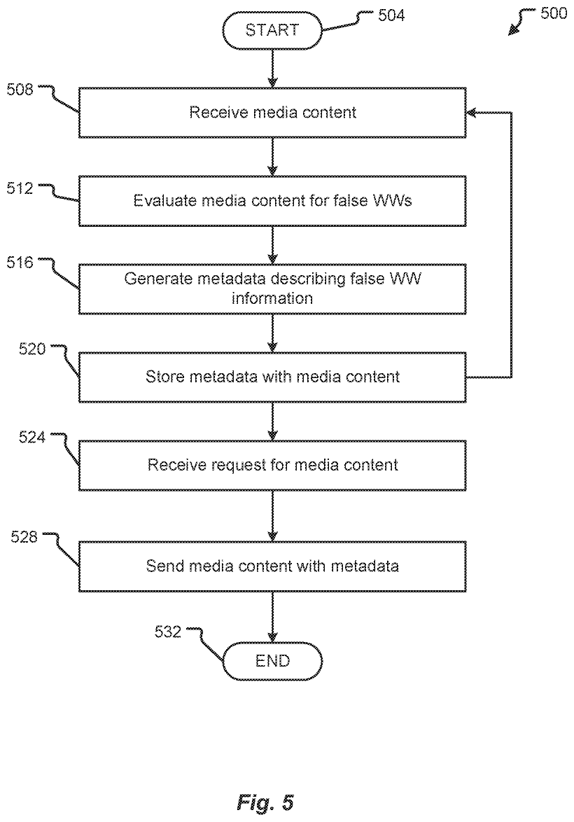

An implementation of a method 500 for creating metadata associated with false WWs may be as shown in FIG. 5. The method 500 can start with a start operation 504 and can end with an end operation 532. The method 500 can include more or fewer stages or can arrange the order of the stages differently than those shown in FIG. 5. The method 500 can be executed as a set of computer-executable instructions, executed by a computer system or processing component, and be encoded or stored on a storage medium. Further, the method 500 can be executed by a gate or other hardware device or component in an ASIC, a FPGA, a SOC, or other type of hardware device. Hereinafter, the method 500 shall be explained with reference to the systems, components, modules, software, data structures, etc. described herein.

The media-delivery system 104 can receive media content, in stage 508. The media server application 184 can receive one or more media content item(s) 232 to the media data store 196. Media data store 196 may store media content items 232. The media data store 196 can be updated with new content from various sources. Upon storing the media content item 232 in the media data store 196, a change processor 242 can indicate the change in the media data store 196 by marking, indicating, and/or storing information regarding the newly added media content item 232 has made a change to the media data store 196. This change may then be provided to the metadata analysis processor 240. The metadata analysis processor 240 can determine if the added content has been analyzed for false WWs. If no such operations have been conducted on the newly added content, the information regarding a need to evaluate for false WWs may be passed to the false WW determiner 212 B.

The media-delivery system 104 may then evaluate media content 232 for false WWs, in stage 512. The multithreaded WW analysis processor 246 may then evaluate the media content item 232 for the presence of false WWs. The multithreaded WW analysis processor 246 may create one or more of the analysis processor 246a-246N threads. The thread(s) 246 may evaluate the media content item 232 for one or more types false WWs. The false WWs may be detected in as a false WW detection 262. Detection is determined when a portion of the media content item 232 is similar to the sound signature of a WW. When there is a match, the false WW determiner 212 can indicate a location of the false WW by determining a false WW start time 264 and a false WW end time 266. These times 264, 266 may be indicated by an offset 268 from a start time 260 of the media content item 232. This false WW information may be provided to the metadata creation/storage processor 248.

Media-delivery system 104 may then generate media content metadata 234 describing the false WW information 308, in stage 516. The metadata creation/storage processor 248 can receive the timing information to 260, 264, 266, associated with the false WW detection 262 in the media content item 232. This false WW information 308 may then be stored within the media content metadata 234 associated with the media content 232. The metadata 234 can include the false WW instance ID 310, the false WW type 312, the false WW offset 314, and/or the false WW duration 316.

Metadata 234 may then be stored with the media content 232, in stage 520. Thus, the metadata 310, 312, 314 can be stored as false WW information 308 in the media content metadata 234. This metadata 234 may be stored and associated with the media content 232. As such, when the media content 232 is requested by a media-playback device 102, media content 232 and the media content metadata 234 may be sent to the media-playback device 102.

Media-delivery system 104 may then receive a request for media content 232, in stage 524. The media-playback device 102 may send a request for media content 232 to the media-delivery system 104 through the communication network(s) 106. This request may be received by the media server application 184, for example, by the media stream service 194. The media stream service 194 can retrieve the media content item 232 and the media content metadata 234.

The media content item 232 and media content metadata 234 may then be streamed as stream 220 through network 106. Thus, the media-delivery system 104 can send media content 232 with the media content metadata 234, in stage 528. Thus, the media-delivery system 104 provides a process for providing false WW information with media content in information through metadata 234 sent to the media-playback device 102.

In implementations, the media-delivery system 104 can receive a request for a media content item 232, in stage 508. This request for media content item 232 may be for content not currently stored in the media data store 196. For example, the media-playback device 102 may be requesting a podcast or live stream event not stored by the media server 180. The request, instead of going directly to the live stream delivery system 108, may be rerouted through the media-delivery system 104. The media-delivery system 104 may then request the content from the live stream delivery system 108. The live stream content may then be sent to the media-delivery system 104 before being forward to the media-playback device 102. The media-delivery system 104 may then analyze, contemporaneously or in near real-time, with sending the media through media stream 219 to the media-playback device 102. Then stages 512 through 528 may be provided for this life stream media content to the media-playback device 102.

In implementations, each packet of live stream media content 232 can be sent from the media-delivery system 104 to the media-playback device 102 in a media stream 219 that may contain metadata. Each item of metadata 234 may include the false WW information 308. Thus, as the WW analysis processor 246 identifies a false WW detection 262, information about the false WW (e.g., data 310-316) may be sent as a packet of metadata 234 the media-playback device 102. In this way, the media-delivery system 104 can provide indications of false WWs in both stored media content item(s) 232 and in the live stream data streamed from a service, e.g., the live stream delivery system 108, but not yet stored in the media data store 196.

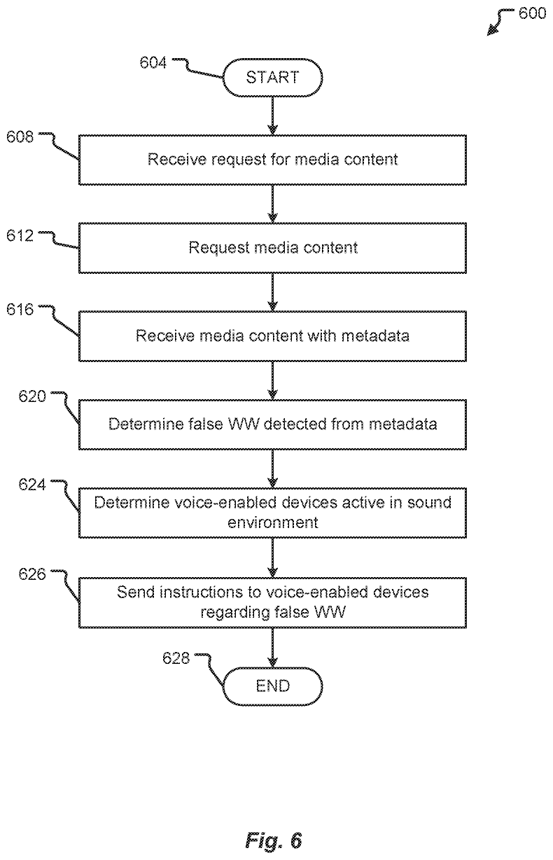

An implementation of a method 600 for instructing voice-enabled devices regarding false WWs may be as shown in FIG. 6. The method 600 can start with a start operation 604 and can end with an end operation 628. The method 600 can include more or fewer stages or can arrange the order of the stages differently than those shown in FIG. 6. The method 600 can be executed as a set of computer-executable instructions, executed by a computer system or processing component, and be encoded or stored on a storage medium. Further, the method 600 can be executed by a gate or other hardware device or component in an ASIC, a FPGA, a SOC, or other type of hardware device. Hereinafter, the method 600 shall be explained with reference to the systems, components, modules, software, data structures, etc. described herein.

The media-playback device 102 can receive a request for media content, in stage 608. The media-playback device 102 can receive user input through a touch screen 152 displaying a user interface 168 and one or more user selectable devices displayed thereon. The user 101 may interact with the user interface 168 to select media content to be played by the media-playback device 102. The touchscreen input may be received by the processing device 154 to obtain and playback the content requested.

The media-playback device 102 can send a request for the media content item 232 to the media-delivery system 104, in stage 612. The processing device 154, of the media-playback device 102, can send the request, as communication(s) 238, to the media-delivery system 104. The request can indicate a media content ID 302 for media content item 232 provided by the media stream service 194.

In some configurations, the request may be for a podcast or other type of live stream media content that is not currently stored at the media-delivery system 104. Thus, rather than sending the request directly to the live stream delivery system 108, the media-delivery system 104 may route the communication for that media content from the media-playback device 102 to the live stream delivery system 108.

The media-delivery system 104 may retrieve or access the content. If the content is a live stream or content not currently stored at the media-delivery system 104, the media may be analyzed by the media content analyzer 210 and the false WW determiner 212 to provide information about false WW detections 262 (data 310-316) contemporaneously or in near real time before sending the media content item(s) 232 back to the media-playback device 102. In other implementations, the media stream service 194 can access the media data store 196 to retrieve the media content items to 232 and the associated media content metadata 234. The media content metadata 234 can include the false WW information 310 through 316. The media stream service 194 may then send the media content 232 and media content metadata 234 back to the media-playback device 102. The media-playback device 102, specifically the processing device 154, can receive media content 232 with the media content metadata 234, in stage 616.

The media-playback device 102 can determine a false WW detected from metadata 234, in stage 620. False WW determiner 212, of the media-playback device 102, can determine that a false WW is present in the media content item(s) 232, based on the false WW information 308 provided in the media content metadata 234. The false WW determiner 212 can extract the media content metadata 234 to determine which voice-enabled devices 110 should be instructed about the presence of the false WW's based on the false WW ID 310 and the false WW type 312.

The false WW determiner 212 can also determine which voice-enabled devices are active in the sound environment 103, in stage 624. The false WW determiner 212 may then generate messages to be sent to the voice-enabled devices 110. The messages may be determined based on information stored by the false WW information 308 and associated with the voice-enabled devices 110 within the sound environment 103. Thus, by correlating the false WW type 312 to the different voice-enabled devices 110 in the sound environment 103, the false WW determiner 212 can create one or more messages for each of the voice-enabled devices 110.

The false WW determiner 212 can then send the instruction messages 406 as output to the voice-enable devices 110 regarding the false WWs, in stage 626. The messages can include a time at which the media playback was started that may correlate to the start time 260. The messages can also include the start time of the false WW 314 and the end time of the false WW 316. This information may be indicated by an offset 268 from the start time 260 and a duration deduced by the end time 266 and the start time 264. The information about timing of the false WW detection 262 allows the voice-enabled device 110 to either disable its voice recognition feature or ignore received false WW's.

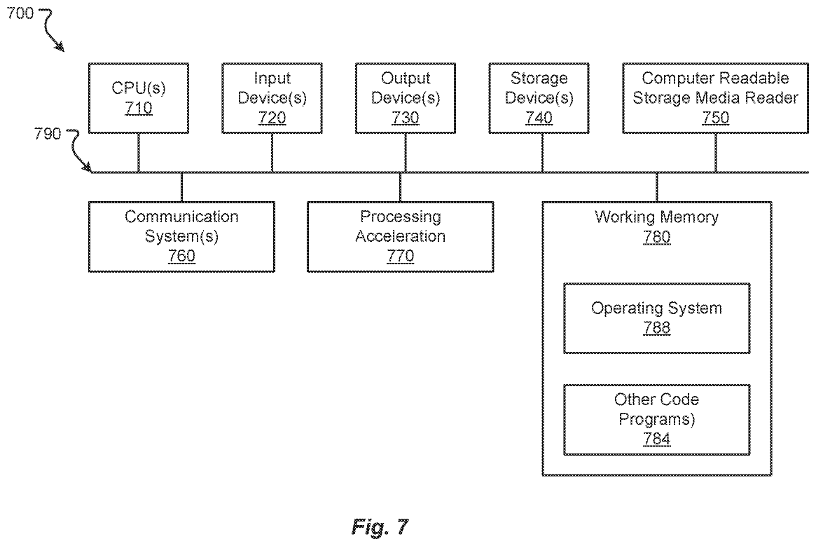

FIG. 7 is a block diagram illustrating an exemplary computer system 700 in which embodiments of the present disclosure may be implemented. This example illustrates a computer system 700 such as may be used, in whole, in part, or with various modifications, to provide the functions of the disclosed system. For example, various functions may be controlled by the computer system 700, including, merely by way of example, generating, determining, identifying. receiving, etc.

The computer system 700 is shown comprising hardware elements that may be electrically coupled via a bus 790. The hardware elements may include one or more central processing units 710, one or more input devices 720 (e.g., a mouse, a keyboard, etc.), and one or more output devices 730 (e.g., a display device, a printer, etc.). The computer system 700 may also include one or more non-transitory computer-readable media such as storage devices 740. By way of example, the storage device(s) 740 may be disk drives, optical storage devices, solid-state storage device such as a random-access memory (“RAM”) and/or a read-only memory (“ROM”), which can be programmable, flash-updateable and/or the like.

The computer system 700 may additionally include a computer-readable storage media reader 750, a communications system 760 (e.g., a modem, a network card (wireless or wired), an infra-red communication device, Bluetooth™ device, cellular communication device, etc.), and a working memory 780, which may include RAM and ROM devices as described above. In some embodiments, the computer system 700 may also include a processing acceleration unit 770, which can include a digital signal processor, a special-purpose processor and/or the like.

The computer-readable storage media reader 750 can further be connected to a computer-readable storage medium, together (and, optionally, in combination with the storage device(s) 740) comprehensively representing remote, local, fixed, and/or removable storage devices plus storage media for temporarily and/or more permanently containing computer-readable information. The communications system 760 may permit data to be exchanged with a network, system, computer and/or another component described above.

The computer system 700 may also comprise software elements, shown as being currently located within the working memory 780, including an operating system 788 and/or other code 784. It should be appreciated that alternative embodiments of a computer system 700 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of the computer system 700 may include code 784 for implementing any or all of the function of the various elements of the architecture as described herein. For example, software, stored on and/or executed by a computer system such as the system 700, can provide the functions of the disclosed system. Methods implementable by software on some of these components have been discussed above in more detail.

Example of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, example of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

While certain example of the disclosure have been described, another example may exist. Furthermore, although example of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, example of the disclosure may be practiced in an electrical circuit comprising discrete electronic elements, packaged or integrated electronic chips containing logic gates, a circuit utilizing a microprocessor, or on a single chip containing electronic elements or microprocessors. Example of the disclosure may also be practiced using other technologies capable of performing logical operations such as, for example, AND, OR, and NOT, including but not limited to, mechanical, optical, fluidic, and quantum technologies. In addition, example of the disclosure may be practiced within a general purpose computer or in any other circuits or systems.

Example of the disclosure may be practiced via a SOC where each or many of the element illustrated in FIGS. 1, 2A, and/or 2B may be integrated onto a single integrated circuit. Such a SOC device may include one or more processing units, graphics units, communications units, system virtualization units and various application functionality all of which may be integrated (or “burned”) onto the chip substrate as a single integrated circuit. When operating via an SOC, the functionality described herein with respect to example of the disclosure, may be performed via application-specific logic integrated with other components of computing device on the single integrated circuit (chip).

Example of the present disclosure, for example, are described above with reference to block diagrams and/or operational illustrations of methods, systems, and computer program products according to example of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for example of the disclosure.

What is claimed is:

1. A method comprising:
analyzing, by a server, an audio stream to be output with a voice-enabled device;
generating, by the server, metadata associated with the audio stream, the metadata describing a portion in the audio stream that includes a false wake word;
storing the metadata with the audio stream; and
providing the metadata with the audio stream to a voice-enabled device.

2. The method of claim 1, wherein the metadata includes a first time indicating a start of the portion of the audio stream that includes the false wake word.

3. The method of claim 2, wherein the first time is indicated by a first offset from a start time of the audio stream.

4. The method of claim 3, wherein the metadata includes a second time indicating an end of the portion of the audio stream that includes the false wake word.

5. The method of claim 4, wherein the second time is indicated by a second offset from the start time of the audio stream.

6. The method of claim 1, wherein the server executes a first wake word analysis processor instance to analyze the audio stream.

7. The method of claim 6, wherein the first wake word analysis processor instance executes before providing the audio stream to the voice-enabled device.

8. The method of claim 6, wherein the first wake word analysis processor instance executes while providing the audio stream to the voice-enabled device.

9. The method of claim 6, wherein the first wake word analysis processor instance detects a first false wake word for a first voice-enabled device and a second wake word analysis processor instance detects a second false wake word for a second voice-enabled device.

10. The method of claim 1, further comprising:
receiving real-time content, at the server, as the audio stream based on a request from the voice-enabled device; and
analyzing, by the server, the audio stream before the audio stream is sent to the voice-enabled device.

11. The method of claim 1, wherein the metadata instructs the voice-enabled device when to deactivate a wake word detector at the voice-enabled device.

12. The method of claim 1, wherein the metadata is provided as part of a metadata service.

13. The method of claim 1, further comprising:
receiving an update to the audio stream;
re-analyzing the audio stream; and
re-generating, by the server, second metadata associated with the audio stream, the second metadata describing a second portion, in the updated audio stream, that includes the false wake word.

14. A media-delivery system comprising:
memory;
a processor, in communication with the memory, that causes the media-delivery system to:
analyze a media content item to be output to a media-playback device, wherein the media-playback device is in presence of a voice-enabled device;
generate metadata associated with a media content item, the metadata describing a portion in the media content item that includes a false wake word;
store the metadata with the media content item; and
provide the metadata with the media content item to the media-playback device, wherein the media-playback device indicates to the voice-enabled device the presence of the false wake word.

15. The media-delivery system of claim 14, wherein a first wake word analysis processor instance executes before providing the media content item to the voice-enabled device.

16. The media-delivery system of claim 14, wherein a first wake word analysis processor instance detects a first false wake word for a first voice-enabled device and a second wake word analysis processor instance detects a second false wake word for a second voice-enabled device.

17. The media-delivery system of claim 14, wherein the processor further causes the media-delivery system to:
receive real-time content based on a request from the voice-enabled device; and
analyze the real-time content before the real-time content is sent to the voice-enabled device.

18. A media-playback device comprising:
memory;
a processor, in communication with the memory, that causes the media-playback device to:
receive a media content item to be output by the media-playback device in presence of a voice-enabled device;
receive metadata associated with the media content item, the metadata describing a portion in the media content item that includes a false wake word;
read the metadata; and
based on the metadata, indicate to the voice-enabled device the presence of the false wake word in the media content item being received by the voice-enabled device.

19. The media-playback device of claim 18, wherein the metadata includes a first time indicating a start of the portion of the media content item that includes the false wake word, wherein the first time is indicated by a first offset from a start time of the media content item.

20. The media-playback device of claim 19, wherein the metadata includes a second time indicating an end of the portion of the media content item that includes the false wake word, wherein the second time is indicated by a second offset from the first time.
